(19) United States
(12) Patent Application Publication
(10) Pub. No.: US 2016/0322152 A1
(43) Pub. Date: Nov. 3, 2016

(54) MAGNETIC CORE

(71) Applicant: KITAGAWA INDUSTRIES CO., LTD., Inazawa-shi (JP)

(72) Inventor: Yoshinori OHASHI, Kitanagoya-shi (JP)

(73) Assignee: KITAGAWA INDUSTRIES CO., LTD., Inazawa-shi (JP)

(21) Appl. No.: 15/097,697

(22) Filed: Apr. 13, 2016

(30) Foreign Application Priority Data
Apr. 28, 2015 (JP) 2015-091657

(51) Int. Cl. H01F 27/24

(52) U.S. Cl. CPC H01F 27/24

(57) ABSTRACT

A magnetic core that includes split magnetic cores provided with a plurality of gaps therebetween. The magnetic core is capable of suppressing the influence of a position shift of the split magnetic cores on magnetic characteristics. A first end face of a first split magnetic core faces a third end face of a second split magnetic core, with a first gap provided therebetween in a left-right direction. Further, a second end face of the first split magnetic core faces a fourth end face of a third split magnetic core, with a second gap provided therebetween in the left-right direction. The first to fourth end faces have a mutually parallel relationship.

### CROSS-REFERENCE TO RELATED APPLICATION

This application is based upon and claims the benefit of priority of the prior Japanese Patent Application No. 2015-091657, filed on Apr. 28, 2015, the entire contents of which are incorporated herein by reference.

### FIELD

The technology disclosed in the present application relates to a core divided by a plurality of gaps.

### BACKGROUND

A magnetic core used in devices such as a coil, a transformer, and a noise filter has gaps provided midway on the magnetic path to suppress the occurrence of magnetic saturation. Examples of this magnetic core include an annular magnetic core, a portion of which is cut out by a cutting process to form a gap that connects the inside space with the outside space of the magnetic core. Nevertheless, when an attempt is made to form such a gap by cutting out a portion of the magnetic core formed into an annular shape by a cutting process, a problem arises that the width of the gap that can be formed is restricted by machining limits, or the width of the gap become distorted, or the like.

In the meantime, it is conceivable to form one core using a plurality of individually separated split magnetic cores, and provide gaps between the split magnetic cores. The magnetic core disclosed in Japanese Laid-open Patent Publication No. 2002-373811A is one core formed by two split magnetic cores. This magnetic core includes spacers inserted into two gaps thereof, and the spacers have a permeability greater than the permeability of air. With such a configuration, the magnetic core suppresses the occurrence of magnetic saturation in each of the split magnetic cores as well as leakage magnetic flux generated from each of the gaps.

### SUMMARY

A magnetic core according to an aspect of the technology disclosed in the embodiments of the present application is a magnetic core that is formed into an annular shape to form an insertion hole through which a conductor is inserted and forms an annular magnetic path. The magnetic core includes a first split magnetic core that forms a part of the annular magnetic path, and a second split magnetic core that sandwiches the first split magnetic core at both ends of the first split magnetic core and forms the other part of the annular magnetic path. The first split magnetic core includes a first end face and a second end face respectively provided to both the ends of the first split magnetic core, and the second split magnetic core includes a third end face facing the first end face, and a fourth end face facing the second end face. The first end face, the second end face, the third end face, and the fourth end face are parallel to each other, and a separation distance between the first end face and the second end face in a direction orthogonal to the first end face is short compared to an inner side distance of the insertion hole in the direction.

The object and advantages of the invention will be realized and attained by means of the elements and combinations particularly pointed out in the claims.

It is to be understood that both the forgoing general description and the following detailed description are exemplary and explanatory and are not restrictive of the invention.

### BRIEF DESCRIPTION OF DRAWINGS

FIG. 1 is a perspective view illustrating a ferrite clamp according to an embodiment in an open state.

FIG. 2 is a schematic view of a closed magnetic core with a conductive bar inserted therethrough.

FIG. 3 is a schematic view of the closed magnetic core with the conductive bar inserted therethrough, as viewed in the front-back direction.

FIG. 4 is a schematic view illustrating the magnetic core with a second split magnetic core shifted in position.

FIG. 5 is a schematic view of a magnetic core of another example, as viewed in the front-back direction.

FIG. 6 is a schematic view of a magnetic core of another example, as viewed in the front-back direction.

FIG. 7 is a schematic view of a magnetic core of a comparative example, as viewed in the front-back direction.

FIG. 8 is a schematic view illustrating the magnetic core of the comparative example with a second split magnetic core shifted in position.

### DESCRIPTION OF EMBODIMENTS

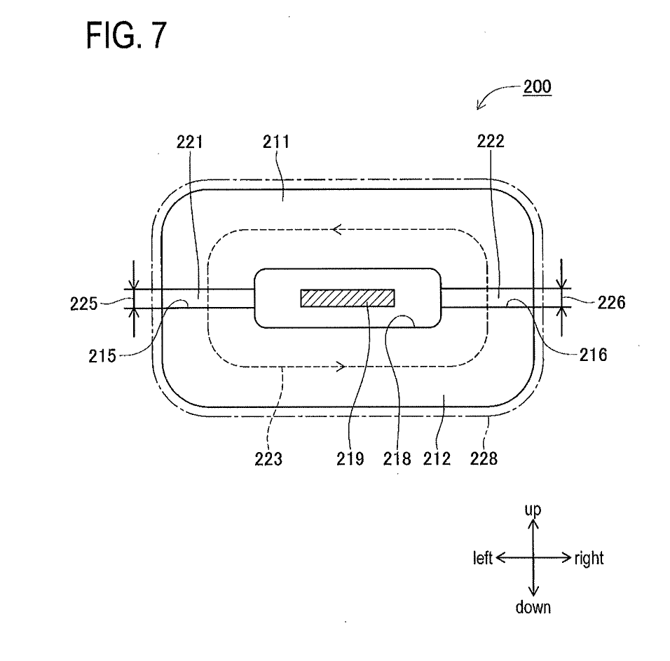

Here, a magnetic core of a comparative example will be described with reference to FIG. 7. A magnetic core 200 illustrated in FIG. 7 is formed into an annular shape with a first split magnetic core 211 and a second split magnetic core 212 facing each other in an up-down direction. An insertion hole 218 formed in a direction orthogonal to the paper surface in FIG. 7 is provided in a center portion of the magnetic core 200. A rectangular shaped conductive bar 219 is inserted into the insertion hole 218.

The first split magnetic core 211 and the second split magnetic core 212 are formed into the same shape, and gaps 215, 216 are provided therebetween in the up-down direction. The gaps 215, 216 are sections facing each other in a left-right direction of the magnetic core 200, and are disposed in the center portion in the up-down direction. The gaps 215, 216 each connect the inside space of the magnetic core 200 with the outside space. The magnetic core 200 is separated into the first split magnetic core 211 on an upper side, and the second split magnetic core 212 on a lower side, with the two gaps 215, 216 placed between the first split magnetic core 211 and the second split magnetic core 212. Further, a spacer 221 for adjusting a gap width 225 of the gap 215 is inserted into the gap 215 on the left side in FIG. 7. Similarly, a spacer 222 for adjusting a gap width 226 of the gap 216 is inserted into the gap 216 on the right side in FIG. 7.

When current flows from the back to the front of the paper in FIG. 7 through the conductive bar 219, for example, a magnetic field is generated around the conductive bar 219. This magnetic field is generated in the direction (direction around the annular shaped magnetic core 200) indicated by an arrow 223 in FIG. 7, forming a magnetic path in the magnetic core 200 that surrounds the conductive bar 219. The gaps 215, 216 form non-continuous portions of the magnetic path indicated by the arrow 223. Thus, a magnetic resistance of the magnetic core 200 is adjusted by adjusting the gap width 225 of the gap 215 and the gap width 226 of the gap 216 using the spacers 221, 222, making it possible to prevent the occurrence of magnetic saturation.

Further, when the first split magnetic core 211 and the second split magnetic core 212 need to be fixed in mutually relative positions, the first split magnetic core 211 and the second split magnetic core 212 are fixed, for example, by being adhered by the adhesive spacers 221, 222, by an insulating resin molded thereon, or by winding an insulating tape member around an outer peripheral surface of the magnetic core 200. As illustrated in FIG. 7, for example, an insulating resin 228 molded on the magnetic core 200 fixes each member of the magnetic core 200, including the first and second split magnetic cores 211, 212. This resin 228 is formed by injection molding, and integrated with the magnetic core 200 and the spacers 221, 222 by insert molding. Nevertheless, the first split magnetic core 211 and the second split magnetic core 212 of the magnetic core 200 may be relatively shifted in position due to the injection pressure of the injection molding, which causes the gap widths 225, 226 to fluctuate. As a result, desired magnetic characteristics may not be obtained, causing difficulties in effectively suppressing the occurrence of magnetic saturation.

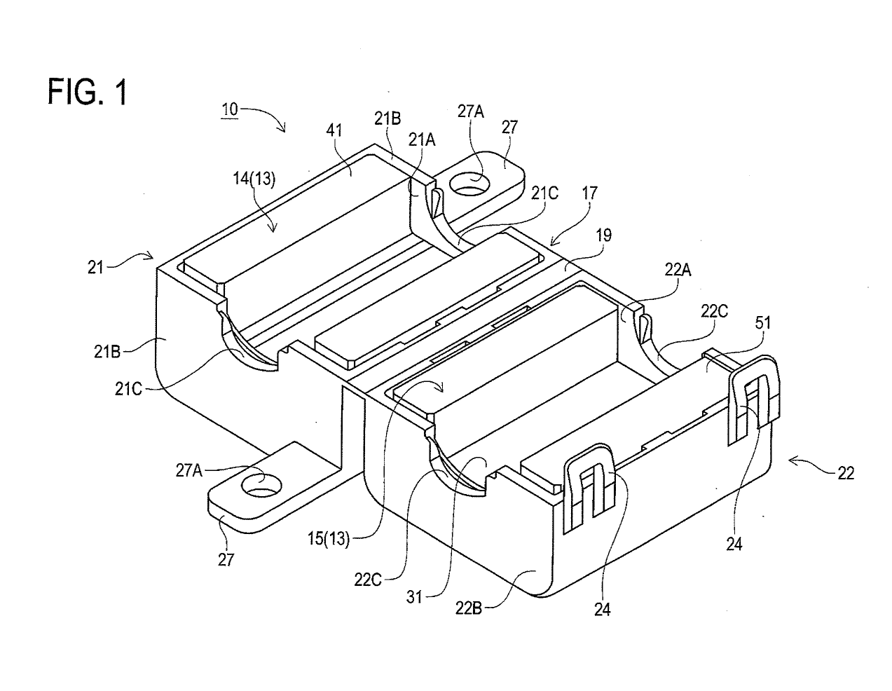

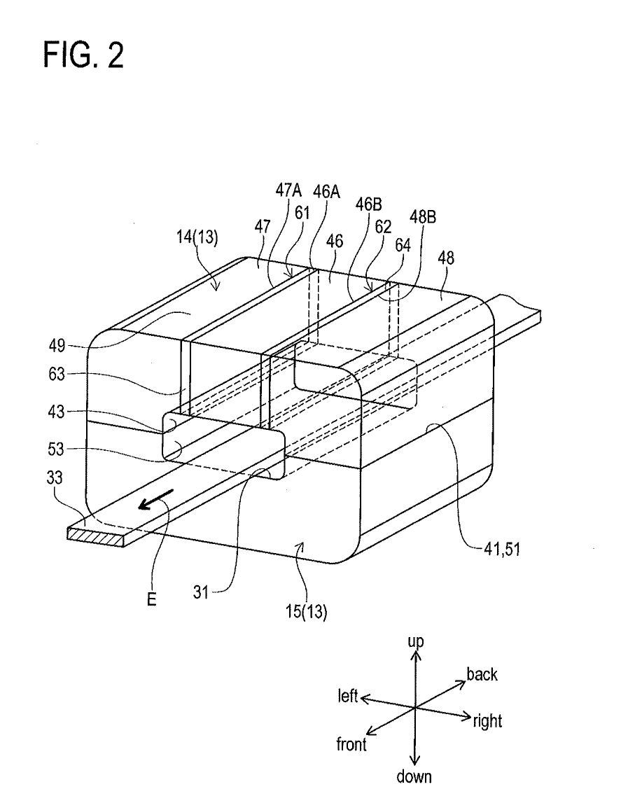

The following describes an embodiment of the present invention while referring to the drawings. FIG. 1 illustrates a ferrite clamp 10 according to the embodiment of the present invention in an open state. FIG. 2 schematically illustrates a closed magnetic core 13 with a conductive bar 33 inserted therethrough and a holding case 17 (refer to FIG. 1) removed.

As illustrated in FIGS. 1 and 2, the ferrite clamp 10 includes the magnetic core 13 and the holding case 17. The magnetic core 13 is, for example, made of a magnetic material such as ferrite, and includes a first magnetic core 14 and a second magnetic core 15. The magnetic core 13 is formed into an annular shape and has an insertion hole 31 in the center portion thereof, through which the conductive bar 33 is inserted. When current flows through the conductive bar 33 inserted through the insertion hole 31, the ferrite clamp 10 functions as a filter that reduces noise included in the current. It should be noted that, in the following description, as illustrated in FIG. 2, the first magnetic core 14 and the second magnetic core 15 of the closed magnetic core 13 are referred to as the upper side and the lower side, respectively, the left side and the right side of the page surface in the insertion direction of the insertion hole 31 is referred to as the frontward direction and the backward direction, respectively, and the left side and the right side of the page surface in the direction orthogonal to the up-down direction and the front-back direction are referred to as the leftward direction and the rightward direction, respectively.

The magnetic core 13 is formed into a substantially rectangular shape having a long outer periphery in the left-right direction as viewed in the front-back direction and a pillar shape whose axis extends in the front-back direction. The insertion hole 31 is formed in the center portion in the up-down direction and the left-right direction of the magnetic core 13, and formed into a substantially rectangular shape that is long in the left-right direction as viewed in the front-back direction. The widths of the insertion hole 31 in the up-down direction and the left-right direction are large compared to those of the conductive bar 33, allowing insertion of the conductive bar 33 through the insertion hole 31. The magnetic core 13 is divided into the first magnetic core 14 and the second magnetic core 15 along planes extending in the front-back direction and the left-right direction that pass through center points of sides extending in the up-down direction. Thus, the first and second magnetic cores 14, 15 are formed into substantially U-shapes that are linearly symmetrical with respect to a line extending in the left-right direction, as viewed in the front-back direction. In the first and second magnetic cores 14, 15, a planar part 41 of the first magnetic core 14 and a planar part 51 of the second magnetic core 15 face each other at the divided section of the magnetic core 13 described above.

The holding case 17 integrally holds the first and second magnetic cores 14, 15, and brings the planar parts 41, 51 into contact with each other, allowing the first and second magnetic cores 14, 15 to close together to form the substantially rectangular pillar shape illustrated in FIG. 2. In the holding case 17, a first bottomed box-shaped case part 21 that houses the first magnetic core 14, and a second bottomed box-shaped case part 22 that houses the second magnetic core 15 are connected in a freely openable and closable manner via a hinge 19. The first case part 21 houses and holds the first magnetic core 14 so that the bottom portion of the U-shaped first magnetic core 14 is located on the bottom surface side of the first case part 21. Similarly, the second case part 22 houses and holds the second magnetic core 15 so that the bottom portion of the second magnetic core 15 is located on the bottom surface side of the second case part 22.

Two rectangular frame-shaped latch frames 24 are provided on a side wall of the second case part 22. This side wall faces, in the left-right direction, a side wall on which the hinge 19 is formed, with a housing part 22A placed therebetween. Latch tabs (not illustrated) that engage with the latch frames 24 of the second case part 22 described above and hold the holding case 17 in a closed state are provided on a side wall of the other first case part 21. This side wall faces, in the left-right direction, a side wall on which the hinge 19 is formed, with a housing part 21A of the first magnetic core 14 placed therebetween. With the latch tabs engaged with the latch frames 24, the holding case 17 holds the magnetic core 13 in an annular shape.

Further, the first case part 21 is, for example, formed by injection molding using an insulating resin, and integrated with the first magnetic core 14 by insert molding. Similarly, the second case part 22 is formed by injection molding, and integrated with the second magnetic core 15 by insert molding. Examples of the materials of the first and second case parts 21, 22 include a phenolic resin, an epoxy resin, an unsaturated polyester, and a nylon resin. Further, a portion of the holding case 17, such as only the hinge 19 that requires pliability, may be formed of a material (a nylon resin or the like) different from that of the other sections.

On each of side walls 21B facing each other in the front-back direction of the first case part 21, a cutout portion 21C for inserting the conductive bar 33 therethrough is formed in correspondence with the insertion hole 31 of the magnetic core 31. The cutout portions 21C are each formed into a substantially semi-circular shape as viewed in the front-back direction. Similarly, on each of side walls 22B facing each other in the front-back direction of the second case part 22, a cutout portion 22C is formed into a substantially semi-circular shape.

Further, a flat plate-shaped fixing portion 27 that protrudes in the front-back direction along the bottom surface of the housing part 21A is provided to each of the side walls 21B of the first case part 21. The pair of fixing portions 27 are disposed diagonally opposite to each other, with a center of the bottom surface of the housing part 21A placed therebetween. A rivet hole 27A is provided in each of the fixing portions 27, allowing the ferrite clamp 10 to be fixed to a support body by inserting a rivet (not illustrated) into this rivet hole 27A.

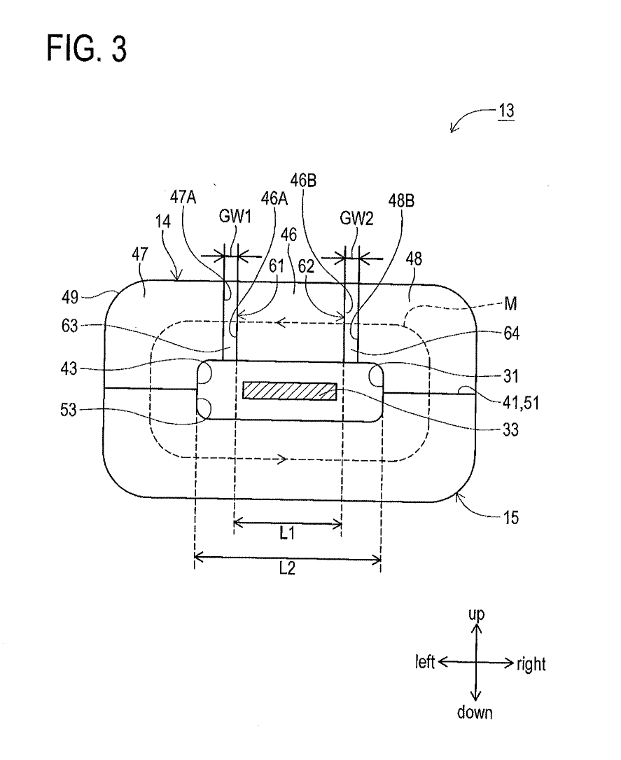

FIG. 3 illustrates the magnetic core 13 in the state illustrated in FIG. 2, as viewed from the front. As illustrated in FIGS. 2 and 3, an inner peripheral surface 43 that forms the U-shape of the first magnetic core 14 and an inner peripheral surface 53 that forms the U-shape of the second magnetic core 15 are disposed facing each other in the up-down direction, thereby forming the insertion hole 31 of the magnetic core 13 into a substantially rectangular-shape that is long in the left-right direction.

Further, in the first magnetic core 14, a first gap 61 and a second gap 62 are formed. The first and second gaps 61, 62 divide the first magnetic core 14 into three split magnetic cores including a first split magnetic core 46, a second split magnetic core 47, and a third split magnetic core 48. The first and second gaps 61, 62 each connect the inner peripheral surface 43 and an outer peripheral surface 49 of the first magnetic core 14, and connect the inside space of the annular shaped magnetic core 13 with the outside space. The first and second gaps 61, 62 may, for example, be formed by cutting out portions of the annular shaped magnetic core 13. Alternatively, the first and second gaps 61, 62 may be provided by separately manufacturing the first to third split magnetic cores 46 to 48 and adjusting the positions of the first to third split magnetic cores 46 to 48.

The first and second gaps 61, 62 are formed in different positions in a section extending in the left-right direction of the first magnetic core 14. In other words, the first and second gaps 61, 62 are provided in different positions in a circumferential direction of the annular shaped magnetic core 13. Of the first to third split circumferential cores 46 to 48, the first split circumferential core 46 is disposed on the right side of the second split circumferential core 47 disposed on the leftmost side, with the first gap 61 placed therebetween in the left-right direction. In the first gap 61, a first end face 46A of the first split magnetic core 46 and a third end face 47A of the second split magnetic core 47 face each other with a predetermined first gap width GW1 therebetween. The first end face 46A and the third end face 47A are each formed by a rectangular flat surface that extends in the up-down direction and the front-back direction. A first spacer 63 is inserted and disposed in the first gap 61.

Further, the third split magnetic core 48 is disposed on the right side of the first split magnetic core 46, with the second gap 62 placed therebetween in the left-right direction. In the second gap 62, a second end face 46B of the first split magnetic core 46 and a fourth end face 48B of the third split magnetic core 48 face each other with a predetermined second gap width GW2 therebetween. A length of the second gap width GW2 is, for example, the same as that of the first gap width GW1. The second end face 46B and the fourth end face 48B are each formed by a rectangular flat surface that extends in the up-down direction and the front-back direction. The respective surface areas of the second end face 46B and the fourth end face 48B are, for example, the same as those of the first end face 46A and the third end face 47A. A second spacer 64 is inserted and disposed in the second gap 62.

Then, in the magnetic core 13 of the present embodiment, the direction orthogonal to both the first end face 46A and the third end face 47A of the first gap 61, and the direction orthogonal to both the second end face 46B and the fourth end face 48B of the second gap 62 extend in the left-right direction (one example of the separation direction). In other words, the first to fourth end faces 46A, 46B, 47A, 48B have a mutually parallel relationship. Furthermore, the first to fourth end faces 46A, 46B, 47A, 48B are in the same position in the up-down direction and the front-back direction. Further, as illustrated in FIG. 3, in the direction (separation direction) orthogonal to the first end face 46A, the separation distance between the first end face 46A and the second end face 46B, that is, a length L1 of the first split magnetic core 46 in the left-right direction, is shorter compared to an inner diameter L2 of the insertion hole 31 in the left-right direction. As a result, when the first split magnetic core 46 is moved in the up-down direction from the state illustrated in FIG. 3, the first split magnetic core 46 comes into contact with neither the second split magnetic core 47 nor the third split magnetic core 48, allowing movement while keeping the first and second gap widths GW1, GW2 constant.

The conductive bar 33 is, for example, made of a conductive material such as copper or aluminum and the like, and is formed into a rectangular plate shape that is long in the front-back direction. The conductive bar 33 connects terminals of various devices, and transmits signals or electric power. When current (noise current) flows through this conductive bar 33 in the direction indicated by the arrow E in FIG. 2, a magnetic field is generated around the conductive bar 33. This magnetic field forms a magnetic path in the magnetic core 13 that surrounds the conductive bar 33, as indicated by the arrow M in FIG. 3. At this time, as the current flowing through the conductive bar 33 increases, the magnetic core 13 becomes more susceptible to exceeding a magnetization capacity (saturation magnetic flux density) and becoming magnetically saturated. Then, when the magnetic core 13 is magnetically saturated, the effect of noise component removal is lost.

Here, the first and second gaps 61, 62 described above are provided to the first magnetic core 14 of the magnetic core 13. The first and second gaps 61, 62 form non-continuous portions of the magnetic path extending in the circumferential direction of the magnetic core 13. Further, the first and second spacers 63, 64 are respectively provided to the first and second gaps 61, 62. Examples of the first and second spacers 63, 64 include a metal piece (copper, silver, or the like) made of a non-magnetic material having the same or substantially the same permeability as air. The first and second spacers 63, 64 have, for example, the same permeability. The first and second gaps 61, 62 and the first and second spacers 63, 64 are magnetic resistance in the magnetic path of the magnetic field generated in the magnetic core 13. As a result, provision of the first and second gaps 61, 62 and the like decreases the magnetic flux density of the magnetic field generated in the magnetic core 13, suppresses the magnetic saturation of the magnetic core 13, and improves the efficiency in removing noise component. Note that the first and second spacers 63, 64 are not limited to the metal piece made of a non-magnetic material, and may be made of a non-magnetic resin material or a combination of these materials.

Incidentally, in the above-described embodiment, the conductive bar 33 is an example of a conductor. The second magnetic core 15, the second split magnetic core 47, and the third split magnetic core 48 are examples of the second split magnetic core. The length L1 is an example of the separation distance.

As described in detail above, in the ferrite clamp 10 of the above-described embodiment disclosed in the present application, the first end face 46A of the first split magnetic core 46 faces the third end face 47A of the second split magnetic core 47 with the first gap 61 provided therebetween in the left-right direction. Further, the second end face 46B of the first split magnetic core 46 faces the fourth end face 48B of the third split magnetic core 48 with the second gap 62 provided therebetween in the left-right direction. The first to fourth end faces 46A, 46B, 47A, 48B have a mutually parallel relationship.

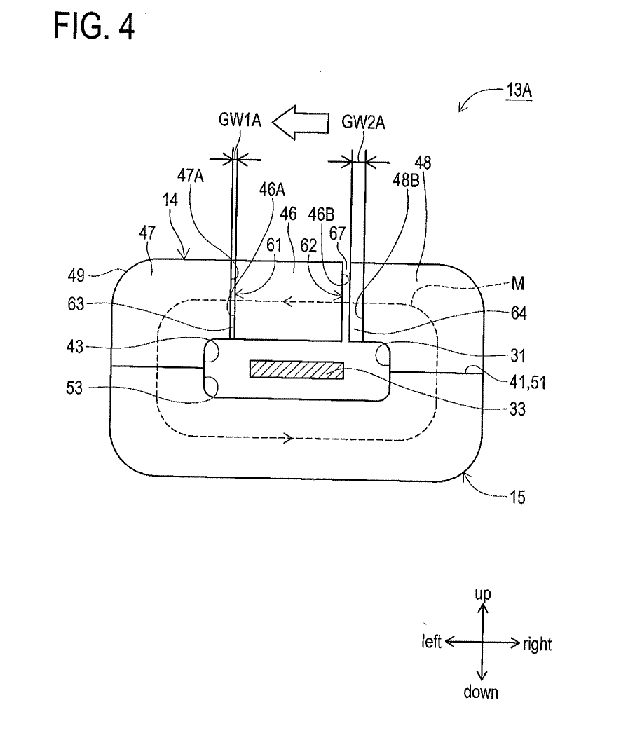

The following describes, for example, a magnetic core 13A in which the first split magnetic core 46 is shifted leftward (toward the second split magnetic core 47) in the left-right direction due to injection pressure when the first case part 21 is formed by insert molding with the first magnetic core 14, as illustrated in FIG. 4. Note that, in the following description, the same components as those of the magnetic core 13 illustrated in FIG. 3 are denoted using the same symbols, and descriptions thereof will be omitted as appropriate.

In the magnetic core 13A illustrated in FIG. 4, a second gap width GW2A has increased to the extent that a first gap width GW1A has decreased as a result of the position shift of the first split magnetic core 46.

The first spacer 63 of the first gap 61 is, for example, compressed by the first split magnetic core 46 moved by injection pressure to the extent that the width of the first gap 61 has decreased from the first gap width GW1 illustrated in FIG. 3 to the first gap width GW illustrated in FIG. 4. On the other hand, in the second gap 62, a gap 67 is formed between the second end face 46B and the second spacer 64 in the left-right direction to the extent that the width of the second gap 62 has increased from the second gap width GW2 illustrated in FIG. 3 to the second gap width GW2A illustrated in FIG. 4. A resin that constitutes the first case part 21 is molded on the magnetic core 13. The gap 67 is formed in the second gap 62. Nevertheless, because the first to fourth end faces 46A, 46B, 47A, 48B have a mutually parallel relationship as described above, the total value of the first and second gap widths GW1A, GW2A is the same as the total value of the first and second gap widths GW1, GW2 of the magnetic core 13, which has not shifted in position, illustrated in FIG. 3.

Further, the magnetic resistance of each of the first and second gaps 61, 62 fluctuates in proportion to the first and second gap widths GW1, GW2. On the other hand, whether there is one gap or a plurality of gaps, the magnetic resistance of the gap(s) having the same total gap width will become constant if all other factors are conditionally the same. Then, in the first magnetic core 14 of the present embodiment, the first to fourth end faces 46A, 46B, 47A, 48B are mutually parallel and have the same surface area. Further, the first and second spacers 63, 64 in the first and second gaps 61, 62 have the same permeability, and are formed of a non-magnetic material having the same or substantially the same permeability as air. Preferably, if a relative permeability is one, the first spacer 63 has the same relative permeability before and after compression. As a result, the magnetic resistance of the first and second gaps 61, 62 of the magnetic core 13 of the present embodiment is the same as the magnetic resistance (including that of an air layer of the gap 67) of the first and second gaps 61, 62 of the magnetic core 13A (illustrated in FIG. 4) in which the first split magnetic core 46 shifts in position. That is, the magnetic characteristics, such as the filter characteristics, of the magnetic core 13 and the magnetic core 13A are the same. Note that, for example, even when the second spacer 64 is fixed (e.g., affixed) to the second end face 46B and the fourth end face 48B that sandwich the second spacer 64 at both ends of the second spacer 64 and is stretched in accordance with the movement of the first split magnetic core 46 illustrated in FIG. 4. Even if the gap 67 is not formed, the magnetic resistance (magnetic characteristics) before and after the movement are the same.

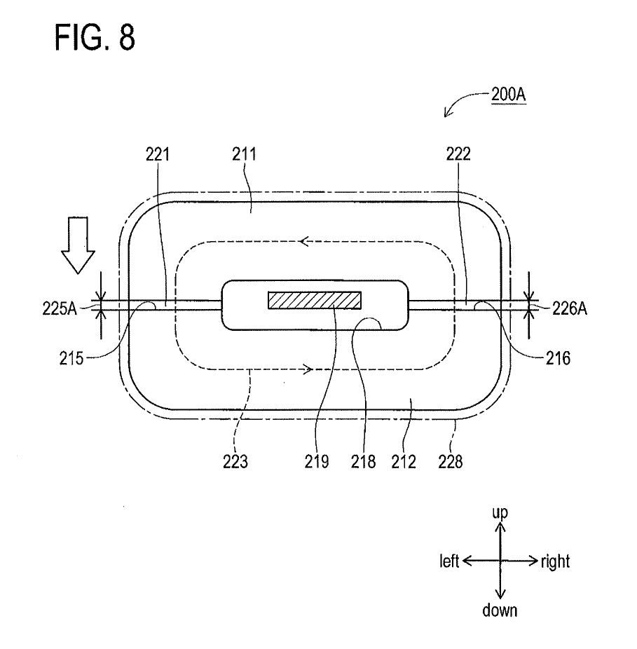

Next, as an example, a case where a first split magnetic core 211 of the magnetic core 200 of the comparative example illustrated in FIG. 7 moves downward will be described. FIG. 8 illustrates, for example, the first split magnetic core 211 shifted downward in the up-down direction due to injection pressure during injection molding. In a magnetic core 200A illustrated in FIG. 8, the end faces that constitute the other gap 216 are positioned in a direction along the end surfaces that constitute the gap 215. As a result, in the magnetic core 200A, the gaps 215, 216 do not have a relationship of canceling between increases and decreases in gap widths 225A, 226A in response to a position shift of the first split magnetic core 211. Then, in the magnetic core 200A, the gap widths 225A, 226A of both of the gaps 215, 216 are decreased by the same amount in response to a position shift of the first split magnetic core 211. The total value of the gap widths 225A, 226A of the gaps 215, 216 of the magnetic core 200A decreases compared to the total value of the gap widths 225, 226 of the magnetic core 200 (illustrated in FIG. 7) without the position shift. As a result, in the magnetic core 200A illustrated in FIG. 8, the magnetic resistance of the two gaps 215, 216 are both smaller compared to those of the gaps 215, 216 of the magnetic core 200 in FIG. 7, making it difficult to maintain desired magnetic characteristics.

In contrast, in the magnetic core 13 of the present embodiment illustrated in FIG. 3, the magnetic resistance, that is, the magnetic characteristics such as filter characteristics, of the first and second gaps 61, 62 are the same compared to those of the magnetic core 13A (refer to FIG. 4) in which the first split magnetic core 46 has shifted in position. As a result, even if the first split magnetic core 46 has shifted in position, the magnetic characteristics are maintained, making it possible to effectively suppress the occurrence of magnetic saturation.

Further, the first and second gaps 61, 62 of the present embodiment are formed in different positions in a section extending in the left-right direction of the first magnetic core 14. The section in which the first and second gaps 61, 62 of this first magnetic core 14 are formed constitutes one side extending in the left-right direction of a portion of the annular shaped magnetic core 13. In such a configuration, when the first and second gaps 61, 62 are formed by a cutting process, for example, it is possible to divide the magnetic core 13 into the first to third split magnetic cores 46 to 48 by cutting, in the up-down direction, the section that extends in the left-right direction. As a result, the mutually parallel first to fourth end faces 46A, 46B, 47A, 48B can be readily formed compared to the case, for example, where a curved section of the first magnetic core 14 is cut.

Note that the technology disclosed in the present application is not limited to the above-described embodiment and, needless to say, various modifications and changes may be made without departing from the spirit of the present application.

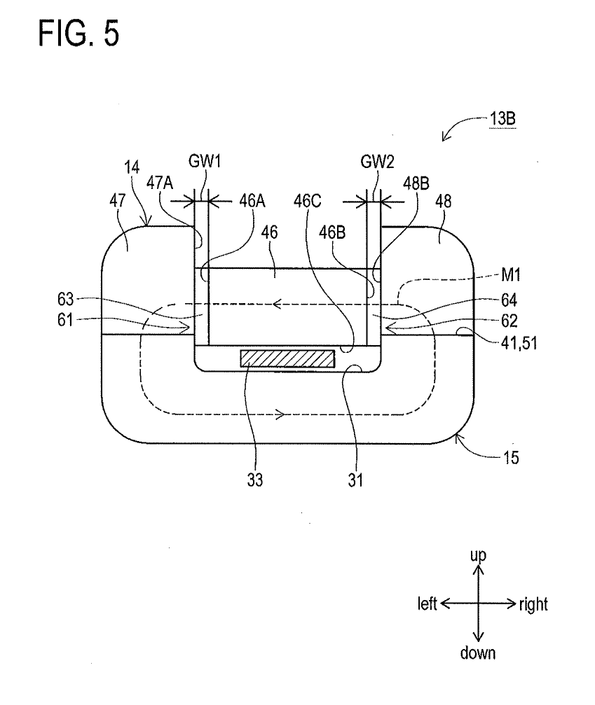

For example, while the first to fourth end faces 46A, 46B, 47A, 48B of the first magnetic core 14 of the magnetic core 13 are in the same position in the up-down direction and the front-back direction, and the outer peripheral surfaces 49 of the first to third split magnetic cores 46 to 48 are flush in the above-described embodiment, the present application is not limited thereto. For example, as illustrated in FIG. 5, the position of the first split magnetic core 46 may be shifted downward (to the inner diameter side of the magnetic core 13) compared to the positions of the second split magnetic core 47 and the third split magnetic core 48. Note that, in the following description, the same components as those of the above-described embodiment are denoted using the same symbols, and descriptions thereof will be omitted as appropriate.

The first split magnetic core 46 of a magnetic core 13B illustrated in FIG. 5 is shifted toward the conductive bar 33 where the inner peripheral surface 46C comes into contact with the conductive bar 33. When the first split magnetic core 46 is disposed in a position where the first split magnetic core 46 comes into contact with or comes close to the conductive bar 33, the insulation properties between the first split magnetic core 46 and the conductive bar 33 are preferably maintained. For example, the first split magnetic core 46 may be made of a material having low conductivity or insulation properties. Alternatively, the conductive bar 33 may have an insulating resin or the like molded thereon. Further, the first magnetic core 14 may have an insulating resin or the like molded on the whole periphery thereof including the inner peripheral surface 46C.

Further, positions of the first and second gaps 61, 62 of the magnetic core 13B differ from those of the magnetic core 13 of the above-described embodiment. Specifically, the third end face 47A of the second split magnetic core 47 is formed in a section formed extending in the up-down direction on the left side of the inner peripheral surface of the insertion hole 31. Similarly, the fourth end face 48B of the third split magnetic core 48 is formed in a section formed extending in the up-down direction on the right side of the inner peripheral surface of the insertion hole 31. Further, the section including the second magnetic core 15, the second split magnetic core 47, and the third split magnetic core 48 has a U-shaped cross section when cut on a plane orthogonal to the front-back direction. The third end face 47A and the fourth end face 48B of the magnetic core 13B are each provided on the inner diameter side of the U-shaped core that includes the second magnetic core 15 and the like. Further, the first split magnetic core 46 is provided on the U-shaped inner diameter side, the first end face 46A faces the third end face 47A, and the second end face 46B faces the fourth end face 48B. In the magnetic core 13B, the surface area of the third end face 47A is larger compared to that of the first end face 46A. Further, the surface area of the fourth end face 48B is larger compared to that of the second end face 46B. On the other hand, the first end face 46A and the second end face 46B have the same surface area, and the surface area of the section of the third end face 47A that faces the first end face 46A is the same as the surface area of the section of the fourth end face 48B that faces the second end face 46B.

In such a configuration, when the first split magnetic core 46 is moved downward from a position on an opening side (upper side in FIG. 5) of the U-shaped core (second magnetic core 15, and the like), in other words, a position where the outer peripheral surface of the first split magnetic core 46 is flush with those of the second split magnetic core 47 and the third split magnetic core 48, toward the conductive bar 33, the first end face 46A and the second end face 46B always face the third end face 47A and the fourth end face 48B, respectively, while remaining parallel. Thus, in the magnetic core 13B, even if the first split magnetic core 46 is shifted in either the left-right direction or the up-down direction by injection pressure or the like, it is possible to maintain constant magnetic resistance of the first and second gaps 61, 62. Then, in the magnetic core 13B, similar to the magnetic core 13 of the above-described embodiment, it is possible to maintain desired magnetic characteristics with respect to a position shift of the first split magnetic core 46.

Further, the magnetic field generated by the current that flows through the conductive bar 33 forms the magnetic path in the magnetic core 13B as indicated by the arrow M1 in FIG. 5. This magnetic path changes in position of formation and decreases in inner diameter by the movement of the first split magnetic core 46, which has high permeability compared to air, toward the conductive bar 33 (downward side). As a result, the magnetic core 13B has a shorter magnetic path length compared to that of the magnetic core 13 (refer to FIG. 3) of the above-described embodiment. Here, the magnetic path length of the magnetic core 13B is inversely proportional to inductance. Thus, in the magnetic core 13A, it is possible to improve magnetic characteristics such as filter characteristics by shortening the magnetic path length to increase inductance.

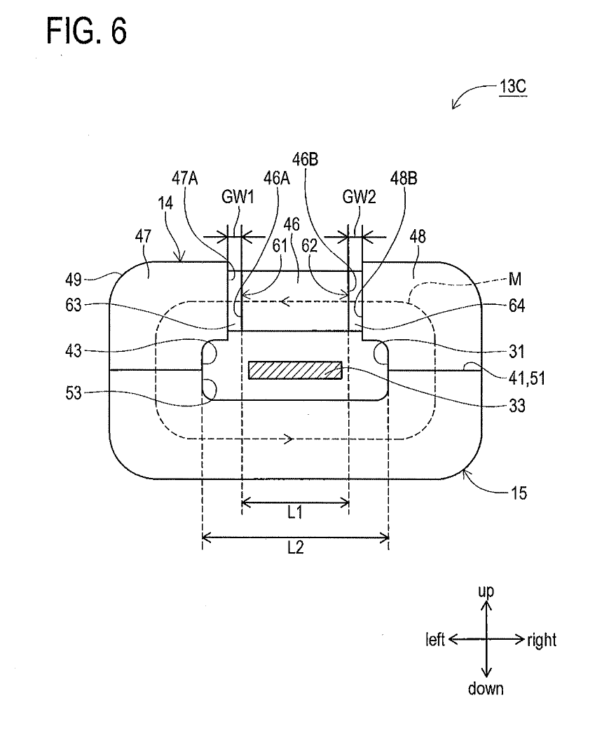

Further, a thickness in the up-down direction of the first split magnetic core 46 may be decreased compared to those of the second split magnetic core 47 and the third split magnetic core 48, as in a magnetic core 13C illustrated in FIG. 6, for example. The first split magnetic core 46 is provided in a position in which a midpoint thereof in the up-down direction matches midpoints of the third end face 47A and the fourth end face 48B in the up-down direction.

With such a configuration, when the first split magnetic core 46 is shifted upward or downward while being located between the second split magnetic core 47 and the third split magnetic core 48, the first end face 46A and the second end face 46B always face the third end face 47A and the fourth end face 48B, respectively, while remaining parallel. As a result, with the magnetic core 13C, similar to the magnetic core 13B illustrated in FIG. 5, it is possible to maintain desired magnetic characteristics with respect to position shifts in the left-right direction and the up-down direction of the first split magnetic core 46.

Further, while the magnetic core 13 is fixed by the holding case 17 molded on the magnetic core 13 in the above-described embodiment, the method of fixing the magnetic core 13 is not limited thereto. For example, the first and second magnetic cores 14, 15 of the magnetic core 13 may be fixed by latches or the like provided to the holding case 17. Further, the first and second magnetic cores 14, 15 may be fixed by winding an insulating tape member around the outer peripheral surface 49 of the magnetic core 13. Further, the first to third split magnetic cores 46 to 48 of the first magnetic core 14 may be fixed to each other by the first and second adhesive spacers 63, 64.

Further, for example, in the magnetic core 13B illustrated in FIG. 5, the magnetic core 13B and the conductive bar 33 may be fixed to each other by an elastic member or the like that biases the first split magnetic core 46 toward the conductive bar 33 located below the first split magnetic core 46. Furthermore, the positions of the first and second magnetic cores 14, 15 may be fixed by combining the methods, such as by molding and the tape member, described above.

Further, in the above-described embodiment, the holding case 17 may be molded on the insertion hole 31 side (inner peripheral surfaces 43, 53) of the magnetic core 13 (the first magnetic core 14 and the second magnetic core 15).

Further, in the above-described embodiment, the holding case 17 may be omitted. For example, the magnetic core 13 may be fixed in an annular shape using a tape member. With such a configuration, even if the first split magnetic core 46 is shifted in position before and after being fixed by the tape member, it is possible to maintain the desired magnetic characteristics.

Further, in the above-described embodiment, the magnetic core 13 may be configured without the first and second spacers 63, 64.

Furthermore, while a non-magnetic material is used for the first and second spacers 63, 64 in the above-described embodiment, a magnetic material (such as a ferrite sheet) may be used when the fluctuation in the magnetic resistance in response to the movement of the first split magnetic core 46 is permitted to a certain degree, for example.

Further, while the above embodiment has described the conductive bar 33 as an example of the conductor of the present application, the conductor is not limited thereto. The conductor of the present application may be a power cable or a signal line that transmits a signal between various devices.

Further, the shape and quantity of each member of the present embodiment are merely examples and may be changed as appropriate. For example, three or more gaps may be provided to the first magnetic core 14. Further, gaps may be provided to both the first magnetic core 14 and the second magnetic core 15. Further, the second magnetic core 15, the second split magnetic core 47, and the third split magnetic core 48 may be integrally formed. Furthermore, the magnetic core 13 is not limited to a substantially rectangular pillar shape, and may be another shape, such as a circular pillar shape, that allows insertion of a conductor such as the conductive bar 33.

The following lists aspects of the embodiment of the present invention. The magnetic core forms the annular magnetic path by the first and second split magnetic cores. The first end face of the first split magnetic core faces the third end face of the second split magnetic core, and a gap can be formed therebetween. Further, the second end face of the first split magnetic core faces the fourth end face of the second split magnetic core, and a gap can be formed therebetween. Here, a magnetic resistance of each gap is proportional to the width of the gap. Further, whether there is one gap or a plurality of gaps, the magnetic resistance of gap(s) having the same total value gap width will become constant if all other factors are conditionally the same.

In the magnetic core of the present application, the first to fourth end faces have a mutually parallel relationship. Here, it is assumed that, for example, when the magnetic core is subject to injection molding, the first split magnetic core moves to one side in the separation direction due to the injection pressure so that the gap between the first end face and the third end face narrows, in other words, the gap between the second end face and the fourth end face widens. In this case, because the first to fourth end faces have a mutually parallel relationship, the total value of the widths of the two gaps is the same or substantially the same as the total value of the widths of the gaps before the first split magnetic core is moved by the injection pressure. Thus, when such a magnetic core provided with gaps is fixed by any of a variety of methods, such as by molding or a tape member, it is possible to maintain desired magnetic characteristics even if at least one of the first and second split magnetic cores moves and then the width of each of the gaps changes, by maintaining the total value of the widths of the gaps before the movement.

Further, the magnetic core of the present application may be configured so that the first split magnetic core extends in the direction orthogonal to the first end face, and the first end face and the second end face face each other in the direction orthogonal to the first end face.

In such a magnetic core, the first split magnetic core constitutes one side extending in the direction orthogonal to the first end face in a portion of the annular shaped magnetic core. With such a configuration, the mutually parallel first to fourth end faces can be readily formed. Specifically, when a portion of the annular shaped magnetic core is cut by a cutting process to form the first to fourth end faces, the first to fourth end faces may be formed by cutting a section (side), which is provided to the portion of the magnetic core and extends in one direction, in a direction orthogonal to the first end face. This cutting process is easy compared to a process of cutting a curved section of the magnetic core to form the first to fourth end faces.

Further, in the magnetic core of the present application, the second split magnetic core may be formed to have a U-shaped cross section, and the first split magnetic core may be disposed so that the first and second end faces face the third and fourth end faces, respectively, the third and fourth end faces being provided on an inner side of the U-shaped cross section of the second split magnetic core.

In such a magnetic core, the first split magnetic core is disposed in a space on the inner side of the second split magnetic core having a U-shaped cross section, and the first and second end faces face the third and fourth end faces, respectively. In such a configuration, when the first split magnetic core is moved from an opening side toward a bottom portion side of the U-shaped second split magnetic core, the first and second end faces always face the third and fourth end faces, respectively, making it possible to maintain a constant magnetic resistance in the gaps. Furthermore, the first split magnetic core is shifted to the inner side of the U-shaped second split magnetic core, thereby shortening a magnetic path length of the annular magnetic path. As a result, the magnetic path length of the magnetic field generated in the magnetic core by current flowing through the conductor inserted in the insertion hole is shortened and inductance is increased, making it possible to improve magnetic characteristics, such as filter characteristics.

According to the magnetic core of the technology disclosed in the present application, it is possible to suppress the effects of a position shift of a split magnetic core on magnetic characteristics.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A magnetic core formed into an annular shape to form an insertion hole through which a conductor is inserted, the magnetic core forming an annular magnetic path, the magnetic core comprising:
a first split magnetic core that forms a part of the annular magnetic path; and
a second split magnetic core that sandwiches the first split magnetic core at both ends of the first split magnetic core and forms the other part of the annular magnetic path,
the first split magnetic core including
a first end face and a second end face respectively provided to both the ends thereof;
the second split magnetic core including
a third end face facing the first end face; and
a fourth end face facing the second end face, wherein:
the first end face, the second end face, the third end face, and the fourth end face being parallel to each other; and
a separation distance between the first end face and the second end face in a direction orthogonal to the first end face being short compared to an inner side distance of the insertion hole in the direction.

2. The magnetic core according to claim 1, wherein
the first split magnetic core is a planar shape extending in the direction orthogonal to the first end face, and the first end face and the second end face face each other in the direction orthogonal to the first end face.

3. The magnetic core according to claim 1, wherein
the second split magnetic core is formed to be provided with a U-shaped cross section, and the first split magnetic core is disposed so that the first end face and the second end face face the third end face and the fourth end face, respectively, the third end face and the fourth end face being provided on an inner side of the U-shaped cross section of the second split magnetic core.
